(19) United States
(12) Patent Application Publication
(10) Pub. No.: US 2024/0027978 A1
(43) Pub. Date: Jan. 25, 2024

(54) SYSTEMS AND METHODS FOR PREDICTING EXTERNAL RESISTIVE FORCES ENCOUNTERED BY INDUSTRIAL MACHINES

(71) Applicants: The Texas A&M University System, College Station, TX (US); Regents of the University of Minnesota, Minneapolis, MN (US)

(72) Inventors: Xingyong Song, Cypress, TX (US); Sencheng Yu, College Station, TX (US); Zongxuan Sun, Plymouth, MN (US)

(73) Assignees: The Texas A&M University System, College Station, TX (US); Regents of the University of Minnesota, Minneapolis, MN (US)

(21) Appl. No.: 18/223,914

(22) Filed: Jul. 19, 2023

Related U.S. Application Data
(60) Provisional application No. 63/390,547, filed on Jul. 19, 2022.

(51) Int. Cl. G05B 13/04; G05B 13/02

(52) U.S. Cl. CPC G05B 13/048; G05B 13/027

(57) ABSTRACT

A computer-implemented method for predicting external resistive forces encountered by an industrial machine includes (a) predicting by a first model a resistive force applied to an industrial machine from an external material using previously collected sensor data, (b) predicting by a second model that is different from the first model an error of the resistive force predicted by the first model using the previously collected sensor data and the resistive force predicted by the first model, and (c) determining a corrected prediction of the resistive force by combining the resistive force predicted by the first model with the error predicted by the second model.

### CROSS-REFERENCE TO RELATED APPLICATIONS

This application claims benefit of U.S. provisional patent application Ser. No. 63/390,547 filed Jul. 19, 2022 and entitled “Systems and Methods for Predicting Resistive Forces Encountered by Industrial Machines,” which is hereby incorporated herein by reference in its entirety for all purposes.

### STATEMENT REGARDING FEDERALLY SPONSORED RESEARCH OR DEVELOPMENT

This invention was made with government support by the U.S. Department of Energy's Office of Energy Efficiency and Renewable Energy (EERE) under the Vehicle Technologies Office Award Number DE-EE0009200.

### BACKGROUND

Industrial machines are utilized in a wide variety of contexts for manipulating (e.g., loading, transporting, and unloading) external objects and materials (e.g., aggregate materials). For example, in the field of construction various types of industrial machines such as excavators, diggers, etc., are utilized for removing materials from a first location (such as by digging the materials from the first location) and transporting the removed materials to a second location distal the first location where the removed materials may be dumped or stored for further use.

### BRIEF SUMMARY OF THE DISCLOSURE

An embodiment of a computer-implemented method for predicting external resistive forces encountered by an industrial machine comprises (a) predicting by a first model a resistive force applied to an industrial machine from an external material using previously collected sensor data, (b) predicting by a second model that is different from the first model an error of the resistive force predicted by the first model using the previously collected sensor data and the resistive force predicted by the first model, and (c) determining a corrected prediction of the resistive force by combining the resistive force predicted by the first model with the error predicted by the second model. In some embodiments, the first model comprises a physical model and the second model comprises one or more neural networks. In some embodiments, the sensor data is collected from one or more sensors of the industrial machine. In some embodiments, the one or more sensors are associated with one or more actuators of the industrial machine. In some embodiments, the sensor data comprises pressure sensor data collected from one or more pressure sensors of the industrial machine. In some embodiments, the method comprises (d) extracting position data and velocity data of a tool of the industrial machine using the previously collected sensor data, (e) providing as an input to the first model the position data of the tool, and (f) providing as an input to the second model the velocity data of the tool. In some embodiments, the second model comprises a neural network having an input layer including the resistive force predicted by the first model, an output layer including the error predicted by the second model, and one or more hidden layers positioned between the input layer and the output layer. In some embodiments, the previously collected sensor data comprises sensor data collected from the industrial machine during one or more prior working cycles conducted by the industrial machine as part of an industrial operation, and the corrected prediction of the resistive force corresponds to a resistive force applied to the industrial machine from an external material during a future working cycle to be conducted by the industrial machine as part of the industrial operation based on a planned trajectory of the industrial machine corresponding to the future working cycle.

An embodiment of a computer-implemented method for predicting external resistive forces encountered by an industrial machine comprises (a) tuning a model using sensor data collected from an industrial machine during one or more prior working cycles conducted by the industrial machine as part of an industrial operation, and (b) predicting by the tuned model a resistive force applied to the industrial machine from an external material during a future working cycle to be conducted by the industrial machine as part of the industrial operation based on a planned trajectory of the industrial machine corresponding to the future working cycle. In some embodiments, the one or more prior working cycles and the future working cycle each comprise an excavating phase in which a tool of the industrial machine excavates a portion of the external material from a pile of the external material. In some embodiments, the planned trajectory of the industrial machine comprises a planned trajectory of a tool of the industrial machine to be executed during the excavation phase of the future working cycle. In some embodiments, the model comprises a neural network. In some embodiments, the model comprises an integrated model including both a physical model and a black box model including one or more neural networks. In some embodiments, the model comprises a physical model but not a black box model. In some embodiments, the sensor data is collected from one or more sensors of the industrial machine. In some embodiments, the method comprises (c) extracting position data and velocity data of a tool of the industrial machine using previously collected sensor data, (d) providing as an input to the model the position data of the tool, and (e) providing as an input to the model the velocity data of the tool In some embodiments, the model comprises a neural network having an input layer including the resistive force predicted by the first model, an output layer, and one or more hidden layers positioned between the input layer and the output layer,

An embodiment of a system for predicting external resistive forces encountered by an industrial machine comprises a processor, a non-transitory memory, and one or more applications stored in the non-transitory memory that, when executed by the processor predict by a first model stored in the non-transitory memory a resistive force applied to an industrial machine from an external material using previously collected sensor data, predict by a second model stored in the non-transitory memory that is different from the first model an error of the resistive force predicted by the first model using the previously collected sensor data and the resistive force predicted by the first model, and determine a corrected prediction of the resistive force by combining the resistive force predicted by the first model with the error predicted by the second model. In some embodiments, the one or more applications stored in the non-transitory memory that, when executed by the processor extract position data and velocity data of a tool of the industrial machine using the previously collected sensor data, provide as an input to the first model the position data of the tool, and provide as an input to the second model the velocity data of the tool. In some embodiments, the previously collected sensor data comprises sensor data collected from the industrial machine during one or more prior working cycles conducted by the industrial machine as part of an industrial operation, and the corrected prediction of the resistive force corresponds to a resistive force applied to the industrial machine from an external material during a future working cycle to be conducted by the industrial machine as part of the industrial operation based on a planned trajectory of the industrial machine corresponding to the future working cycle.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of exemplary embodiments of the disclosure, reference will now be made to the accompanying drawings in which:

FIG. 1 is a perspective view of an embodiment of an industrial machine in accordance with principles disclosed herein;

FIG. 2 is a block diagram of an embodiment of a system for predicting external resistive forces encountered by an industrial machine in accordance with principles disclosed herein;

FIG. 3 is a diagram illustrating an embodiment of a linkage assembly of an industrial machine in accordance with principles disclosed herein;

FIG. 4 is a block diagram of an embodiment of an integrated or hybrid model in accordance with principles disclosed herein;

FIG. 5 is a diagram illustrating an embodiment of a bucket in accordance with principles disclosed herein;

FIG. 6 is another diagram illustrating an embodiment of a bucket in accordance with principles disclosed herein;

FIG. 7 is another diagram illustrating an embodiment of a bucket in accordance with principles disclosed herein;

FIG. 8 is a block diagram of an embodiment of a neural network in accordance with principles disclosed herein;

FIG. 9 is a diagram of an embodiment of a working cycle of an industrial machine in accordance with principles disclosed herein;

FIGS. 10-13 are graphs illustrating predicted external resistive forces as a function of time in accordance with principles disclosed herein;

FIG. 14 is a block diagram of an embodiment of a computer system in accordance with principles disclosed herein;

FIG. 15 is a flowchart of an embodiment of a method for predicting external resistive forces encountered by an industrial machine in accordance with principles disclosed herein; and

FIG. 16 is a flowchart of another embodiment of a method for predicting external resistive forces encountered by an industrial machine in accordance with principles disclosed herein.

### DETAILED DESCRIPTION OF THE DISCLOSED EMBODIMENTS

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. Further, as used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

As described above, industrial machines are utilized in a wide variety of contexts for manipulating external objects and materials such as, for example, the industrial machines (e.g., excavators, diggers, wheel loaders) used in the performance of construction operations. In addition, industrial machines encounter external resistive forces applies to the industrial machine by the external object or material engaged by the machine. For example, the process of digging materials such as earthen materials from the ground using a digger consumes a substantial amount of power to permit a tool of the industrial machine (e.g., a bucket of a digger) to overcome the external resistive forces encountered by the tool (e.g., forces applied to the tool by the earthen material engaged by the tool) as the tool engages the material.

While conventionally such industrial machines have been controlled or driven manually by a human operator, efforts have been made to at least partially automate the operation of such industrial machines in the interest of minimizing the amount of manual human labor (thereby minimizing safety hazards and/or labor costs) required to perform an industrial operation such as, for example, a construction operation. It may be understood that the optimal design of an automated control system for operating one or more industrial machines requires an accurate model of the power consuming processes encountered by the one or more industrial machines controlled by the automated control system. Moreover, given that, as described above, much of the power consumed by an industrial machine during operation results from the external resistive forces applied to the tool of the industrial machine in operation, it may be beneficial to predict the external resistive forces encountered by the tool during operation as part of an automated control regimen configured to minimize the amount of power consumed by the industrial machine during operation. As an example, a bucket scooping operation performed by a wheel loader consumes a significant portion of power to overcome soil resistant forces applied to the bucket. However, soil resistance forces encountered by industrial machines (e.g., wheel loaders) is affected by myriad factors and conventional models typically are either too complex for on-line or real-time applications (e.g., control systems configured to control one or more industrial machines in real-time) or are too simplistic and inaccurate for many applications.

Particularly, conventional models of soil-tool interaction forces (a g., external resistive forces encountered by a tool of an industrial machine during operation) typically comprise physics-based models including numerical models and analytical models, Numerical models using finite element analysis (EEA) typically have a high degree accuracy, but incur a correspondingly high computational cost making the use of FEA-based models impractical for use in real-time control systems and instead are ordinarily employed in off-line analysis and planning of a given industrial operation.

On the other hand, analytical physical models typically simplify the modeling of soil-tool interaction forces by classifying such forces as composed of four distinct components: soil cohesion, weight, adhesion, and surcharge. As used herein, the term “physical model” is defined as a model which invokes the laws of physics (e.g., Newtonian mechanics, soil mechanics) to describe the behavior of a system. In other words, physical models attempt to directly model the physical interactions of components of the system. Physical models may be distinguished from “black box” models which focus on the relationships between inputs and outputs of the model instead of the theoretical underpinnings or character of the system. One such physical model is the fundamental earthmoving equation (FEE) model which provides force estimates using the parameters of soil properties and the relative position of the bucket and the soil pile. However, the FEE model is generally based on simplified soil-tool interaction mechanics and cannot ensure high estimation accuracy under various operating conditions, especially operating conditions which are transient in nature.

In addition to analytical physical models, data-driven or “black box” models have also been developed which include, for example, linear regression models, k-nearest neighbor models, and neural network (NN) models. However, conventional black box models typically employ crude modeling structures making it difficult for such models to provide accurate estimates across different operating conditions, especially those not fully covered by the training dataset used to train the respective black box model.

Accordingly, embodiments of systems and methods for predicting external resistive forces encountered by industrial machines, such as the external resistive forces encountered by a digger as the bucket of the digger digs into the Earth, are disclosed herein. In some embodiments, methods disclosed herein include operating an industrial machine whereby a tool of the industrial machine encounters an external material, providing as an input one or more parameters associated with movement of the tool of the industrial machine to a black box model including a neural network whereby a physical model associated with the industrial machine is integrated with the black box model, and predicting external resistive forces applied to the tool by the external object in response to the tool encountering the external object. In some embodiments, an output of the neural network may correct an output of the physical model. For example, an output of the neural network may predict an error of an estimated external resistive force provided by the physical model.

In certain embodiments, a method for predicting external resistive forces is provided in which a model (e.g., an integrated model, a black box model) is trained using sensor data collected from an industrial machine during one or more prior working cycles conducted by the industrial machine as part of an industrial operation, and the trained model predicts a resistive force applied to the industrial machine from an external material during a future working cycle to be conducted by the industrial machine as part of the industrial operation based on a planned trajectory of the industrial machine corresponding to the future working cycle. In this manner, the model may be trained using “online” data captured during the performance of a previous working cycle conducted by the respective industrial machine such that changes to the operating environment may be leveraged to train the model.

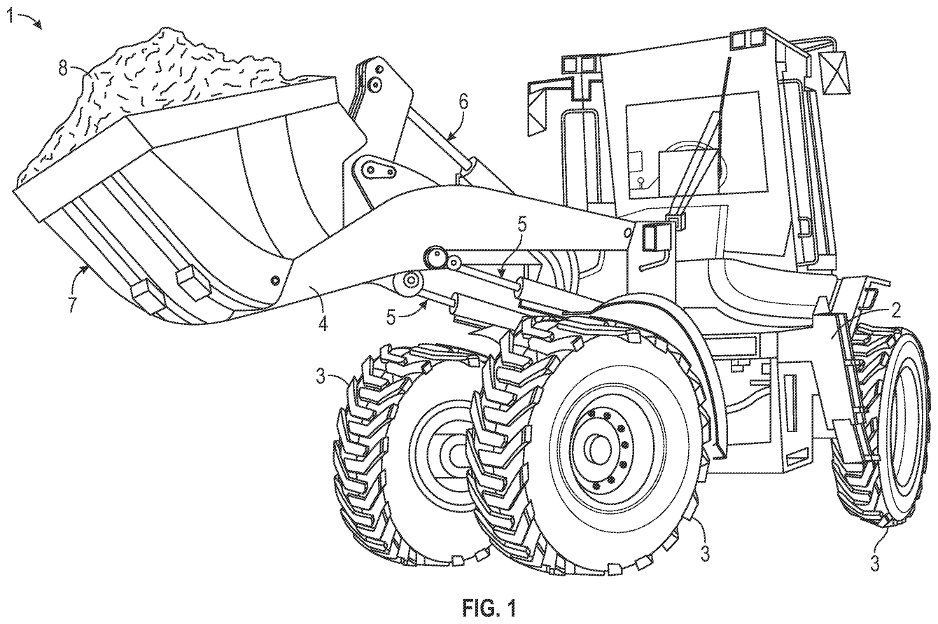

Referring initially to FIG. 1, an embodiment of an exemplary industrial machine 1 is shown, The industrial machine 1 shown in FIG. 1 comprises a wheel loader having a chassis 2, a plurality of driven wheels 3 supporting the chassis 2, a lift arm 4 pivotably coupled to the chassis 2, one or more hydraulic lift cylinders 5 coupled between the lift arm 4 and the chassis 2, one or more hydraulic tilt cylinders 6 coupled to the chassis 2, and a tool 7 in the form of a bucket coupled to a terminal end of the lift arm 4 for scooping and lifting external material 8 (a g., soil or other aggregate materials). The cylinders 5 and 6 are hydraulically powered in this exemplary embodiment and define linear actuators for manipulating the pose of the bucket 7 with respect to the chassis 2. Additionally, cylinders 5 and 6 are each equipped with pressure sensors for monitoring hydraulic pressure within the respective cylinders 5 and 6.

industrial machine 1 encounters various external resistive forces during the performance of tasks as part of an industrial operation, such as a construction operation. For example, as the tool 7 scoops into a pile of the external material 8, the tool 7 encounters external resistive forces from the external material 8 as the material 8 is scooped into the tool 7 and then lifted using the cylinders 5 and 6 of industrial machine 1. The external resistive forces applied to the industrial machine 1 by external material 8 is registered by the pressure sensors of cylinders 5 and 6 (ag,, the pressures within cylinders 5 and 6 may be elevated in response to the external resistive forces applied by external material 8 relative to performing the same task (e.g., lifting the tool 7) with the tool 7 being empty of external material 8).

The illustration of industrial machine 1 serves as an example of an industrial machine in the discussion to follow, and it may be understood that industrial machines encompassed by this disclosure extend beyond wheel loaders and other construction machinery. For example, in certain embodiments, industrial machine 1 comprises excavators, backhoe loaders, skid-steer loaders, track loaders, and others.

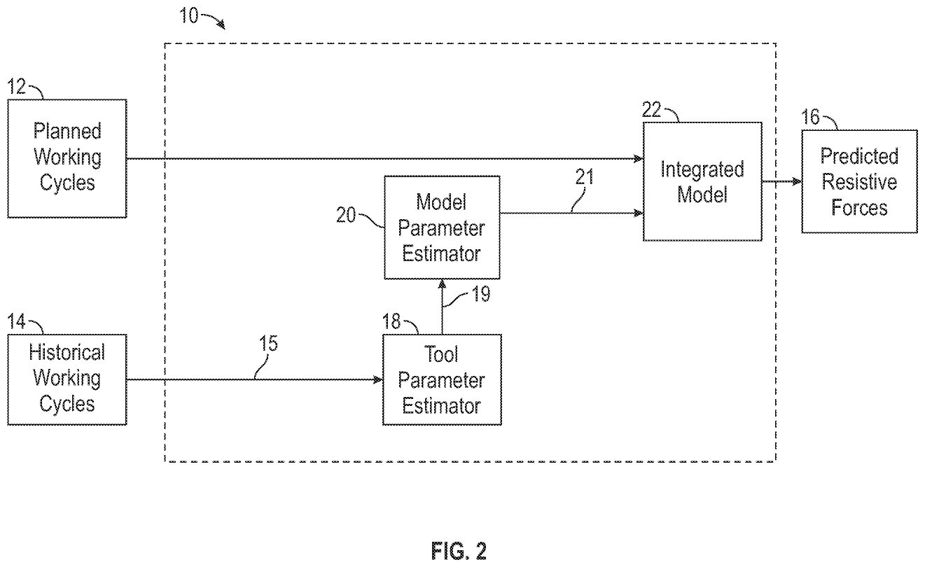

Referring to FIG. 2, an embodiment of a system 10 for predicting external resistive forces encountered by industrial machines is shown. In this exemplary embodiment, force prediction system 10 receives a pair of inputs 12 and 14, and produces or generates an output 16. Particularly, a first input 12 of the pair of inputs 12 and 14 comprises planned working cycle data (also referred to herein as planned working cycle input 12) while the second input 14 of the pair of inputs 12 and 14 comprises historical working cycle data (also referred to herein as historical working cycle input 14). The planned working cycle input 12 pertains to planned, future working cycles to be performed by an industrial machine (e.g., industrial machine 1 shown in FIG. 1). As used herein, the term “working cycle” is defined as a task performed by an industrial machine as part of an industrial operation. As an example, a working cycle may comprise industrial machine 1 shown in FIG. 1 scooping and lifting external material 8 using tool 7 as part of a construction operation. It may be understood that respective working cycles may be repeated several or many times during the performance of an industrial operation.

In some embodiments, the planned working cycle input 12 includes a planned control trajectory of a tool of an industrial machine executed as part of a planned working cycle. For instance, a planned control trajectory may comprise the planned trajectory of the tool 7 of industrial machine 1 to be executed as part of a working cycle in which the tool 7 scoops and lifts external material 8. In this exemplary embodiment, the output 16 of force prediction system 10 comprises the predicted external resistive forces applied to the industrial machine in response to the execution of a planned working cycle (e.g., a planned control trajectory of a tool of an industrial machine) by an industrial machine where the planned working cycle is captured by planned working cycle input 12.

The historical working cycle input 14 of force prediction system 10 comprises data collected from the execution of previous working cycles (including, e.g., the execution of previous control trajectories by a tool of an industrial machine) by an industrial machine. In some embodiments, historical working cycle input 14 comprises sensor data 15 collected by sensors of an industrial machine. As an example, sensor data 15 may include hydraulic pressure sensor data of the cylinders 5 and 6 of industrial machine 1 collected by sensors of the industrial machine 1 during the previous execution of a working cycle by the industrial machine 1 (e.g., a previous excavation of external material 8 by the industrial machine 1). In addition, sensor data 15 may include position sensor data of the cylinders 5 and 6 collected by one or more position sensors of the industrial machine 1 and which corresponds to the current degree of linear extension of the given cylinder 5 and 6. Typically, such pressure and position sensors are already present on many industrial machines 1 relying on hydraulic actuation, and thus in many instances no additional sensors need be added to the industrial machine in order to capture the sensor data 15 outputted from historical working cycle input 14,

In this manner, force prediction system 10 is generally configured to provide an output 16 corresponding to predicted external resistive forces applied to the industrial machine in response to the execution of a planned working cycle (captured by planned working cycle input 12) by an industrial machine and which is based on previous working cycles (captured by historical working cycle input 14) executed by the industrial machine (or other industrial machines similar in configuration to the respective industrial machine).

In this exemplary embodiment, force prediction system 10 generally includes a tool variable estimator 18, a model parameter estimator 20, and an integrated model 22 which collectively configured to produce the output 16 from the inputs 12 and 14 received by force prediction system 10. The tool variable estimator 18 receives the sensor data 15 as an input and is generally configured to estimate the trajectory of a tool of an industrial machine produced during the performance a prior working cycle based on sensor data (e.g., pressure and position sensors of industrial machine 1 as described above) collected from the industrial machine (and captured by historical working cycle input 14) during the execution of the past working cycle. In this exemplary embodiment, the tool variable estimator 18 comprises a Lagrangian model for estimating the trajectory of the tool from the available sensor data, in other embodiments models other than a Lagrangian model may be used for this purpose. For example, in other embodiments, a linkage analysis model may be used based on Newtonian mechanics. In addition, tool variable estimator 18 is also configured to estimate external resistive forces 19 applied to the tool of the industrial machine during the performance of the past working cycle.

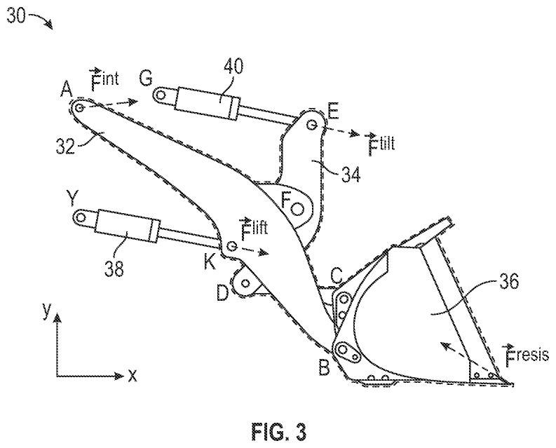

Referring now to FIG. 3, a diagram illustrating a linkage assembly 30 of an industrial machine (e.g., a wheel loader) is shown. FIG. 3 illustrates a lift arm 32, a lever 34 coupled to the lift arm 32, a tool or bucket 36 pivotably coupled to the lift arm 32, a lift cylinder 38 pivotably coupled to the lift arm 32, and a tilt cylinder 40 pivotably coupled to the lever 34. It may initially be understood that reference to linkage assembly 30 is only meant to serve as one illustrative example of the implementation of the tool variable estimator 18 shown in FIG. 2, and thus the Lagrangian model described below may similarly be applied to industrial machines having linkage systems which differ in configuration from the linkage assembly 30 shown in FIG. 3.

In this example, utilizing a Lagrangian model (e.g., tool variable estimator 18 shown in FIG. 2), the motion or trajectory of the bucket 36 and the external resistive forces applied to the bucket 18 may be estimated based on sensor data (e.g., pressure sensor data and position sensor data) obtained from cylinders 38 and 40 without needing to directly obtain force data from the bucket 36 (e.g., via force sensors attached to the bucket 36 for the purpose of collecting such sensor data).

Without intending to be bound by any particular theory, the dynamics of linkage assembly 30 may be expressed in accordance with Equation (1) below where the Lagrangian of the selected system (L) corresponds to the difference of the kinetic energy (T) and the potential energy (V) (e.g., L), (q) represents the generalized coordinate of the system, (\vec{F}ₑₓₜ^{nc}) represents the vector of the external non-conservative force acting on the system, and (\vec{r}) represents the position vector of the corresponding force.

$$\frac{d}{d t} ( \frac{\partial ℒ}{\partial \dot{q}} ) - \frac{\partial ℒ}{\partial q} = \sum ( {\vec{F}}_{ext}^{nc} \cdot \frac{\partial \vec{r}}{\partial q} ) \qquad ( 1 )$$

A Lagrangian model of linkage assembly 30 may be implemented by considering the lift arm 32, lever 34, and bucket 36. In this exemplary embodiment, linkage assembly 30 has three degrees-of-freedom (DOFs) such that the pose of linkage assembly 30 is determined by the longitudinal extensions or lengths of the lift cylinder 38 and the tilt cylinder 40. In addition, the whole system moves together in concert with the industrial machine or vehicle comprising linkage assembly 30. The displacements of lift cylinder 38, tilt cylinder 40 and of the industrial machine itself may be selected as three generalized coordinates: q₁=d_{lift}, q₂=dₜᵢₗₜ, and q₃=dᵥₑₕ. Not intending to be bound by any particular theory, the kinetic energy (T) and potential energy (V) for each component may be expressed in accordance with Equations (2) and (3) presented below for iϵS,S={LiftArm,Lever,Link,Bucket}, where (mⁱ) represents the mass of each component, (x_{cm}ⁱ,y_{cm}ⁱ) represents the position of the center of mass, (J_{cm}ⁱ) represents the moment of inertia of the component about its center of mass, and (g) represents the gravitational acceleration:

$${T}_{i} ( {q}_{1} , {q}_{2} , {q}_{3} , {\dot{q}}_{1} , {\dot{q}}_{2} , {\dot{q}}_{3} ) = \frac{1}{2} {m}^{i} ( {{\dot{x}}_{c m}^{i}}^{2} + {{\dot{y}}_{c m}^{i}}^{2} ) + \frac{1}{2} {J}_{c m}^{i} {{ω}_{c m}^{i}}^{2} \qquad ( 2 )$$

$${V}^{i} ( {q}_{1} , {q}_{2} , {q}_{3} ) = {m}^{i} g {y}_{c m}^{i} \qquad ( 3 )$$

Not intending to be bound by any particular theory, the Lagrangian model of the system (e.g., linkage assembly 30) may be expressed in accordance with Equation (4) presented below while the derivatives of the Lagrangian model may be expressed in accordance with Equations (5) and (6) presented below:

$$ℒ ( {q}_{1} , {q}_{2} , {q}_{3} , {\dot{q}}_{1} , {\dot{q}}_{2} , {\dot{q}}_{3} ) = {\sum }_{i ∈ S} ( {T}^{i} - {V}^{i} ) \qquad ( 4 )$$

$$\frac{d}{d t} ( \frac{\partial ℒ}{\partial {\dot{q}}_{i}} ) = {\sum }_{j ∈ S} [ {m}_{c m}^{i} ( {\ddot{x}}_{c m}^{j} \frac{\partial {\dot{x}}_{c m}^{j}}{\partial {\dot{q}}_{i}} + {\ddot{y}}_{c m}^{j} \frac{\partial {\dot{x}}_{c m}^{j}}{\partial {\dot{q}}_{i}} ) + {J}_{c m}^{j} {\dot{ω}}_{c m}^{j} \frac{\partial {\dot{ω}}_{c m}^{j}}{\partial {\dot{q}}_{i}} + {m}_{c m}^{j} {\dot{x}}_{c m}^{j} {{\sum }_{k = 1}}^{3} ( \frac{{\partial }^{2} {\dot{x}}_{c m}^{j}}{\partial {q}_{k} {\dot{q}}_{i}} {\dot{q}}_{k} + \frac{{\partial }^{2} {\dot{x}}_{c m}^{j}}{\partial {\dot{{q}_{k} q}}_{i}} {\ddot{q}}_{k} ) + {m}_{c m}^{j} {\dot{y}}_{c m}^{j} {{\sum }_{k = 1}}^{3} ( \frac{{\partial }^{2} {\dot{y}}_{c m}^{j}}{\partial {q}_{k} {\dot{q}}_{i}} {\dot{q}}_{k} + \frac{{\partial }^{2} {\dot{y}}_{c m}^{j}}{\partial {\dot{{q}_{k} q}}_{i}} {\ddot{q}}_{k} ) + {J}_{c m}^{j} {ω}_{c m}^{j} {{\sum }_{k = 1}}^{3} ( \frac{{\partial }^{2} {ω}_{c m}^{j}}{\partial {q}_{k} {\dot{q}}_{i}} {\dot{q}}_{k} + \frac{{\partial }^{2} {ω}_{c m}^{j}}{\partial {\dot{{q}_{k} q}}_{i}} {\ddot{q}}_{k} )$$

$$\frac{\partial ℒ}{\partial {q}_{i}} = {\sum }_{j ∈ S} [ {m}^{j} ( {\dot{x}}_{c m}^{j} \frac{\partial {\dot{x}}_{c m}^{j}}{\partial {\dot{q}}_{i}} + {\dot{y}}_{c m}^{j} \frac{\partial {\dot{y}}_{c m}^{j}}{\partial {\dot{q}}_{i}} ) + {J}_{c m}^{j} {ω}_{c m}^{j} \frac{\partial {ω}_{c m}^{j}}{\partial {q}_{i}} - {m}^{j} g \frac{\partial {y}_{c m}^{j}}{\partial {q}_{i}} ] \qquad ( 6 )$$

Four external non-conservative forces act on the system; the force of lift cylinder 38 (indicated by arrow \vec{F}^{lift} in FIG. 3), the force of tilt cylinder 40 (indicated by arrow \vec{F}^{tilt} in FIG. 3), the external resistive force (e.g., a soil resistance force, indicated by arrow \vec{F}^{resis} in FIG. 3), and the interaction force between the system and the vehicle (indicated by arrow \vec{F}^{int} in FIG. 3). Of these four distinct forces, the forces of cylinders 38 and 40 may be determined via pressure sensor data obtained from cylinders 38 and 40 (e.g., force of lift cylinder 38 corresponds to the product of the hydraulic pressure and the effective surface area of lift cylinder 38).

Not intending to be bound by any particular theory, the force of lift cylinder 38 may be expressed in the coordinate system shown in FIG. 3 in accordance with Equation (7) presented below while the force of tilt cylinder 40 may be expressed in the coordinate system of FIG. 3 in accordance with Equation (8) presented below, where the terms (K, Y, E, and G) represent the joints K, Y, E, and G shown in FIG. 3, (l_{lift}) represents the length of lift cylinder 38, and (lₜᵢₗₜ) represents the length of tilt cylinder 40:

$${F}_{x}^{lift} = {F}^{lift} \frac{{x}_{K} - {x}_{Y}}{{l}_{lift}} , {F}_{y}^{lift} = {F}^{lift} \frac{{y}_{K} - {y}_{Y}}{{l}_{lift}} \qquad ( 7 )$$

$${F}_{x}^{lift} = {F}^{lift} \frac{{x}_{E} - {x}_{G}}{{l}_{lift}} , {F}_{y}^{lift} = {F}^{lift} \frac{{y}_{E} - {y}_{YG}}{{l}_{lift}} \qquad ( 8 )$$

Not intending to be bound by any particular theory, given that the force of lift cylinder 38 facts on joint K, the force of tilt cylinder 40 acts on joint E, and resistance force acts on the bucket tip, and the system-vehicle interaction force acts on the joint A, the right-hand side of Equation (1) may be expressed in accordance with Equation (9) presented below for i=1, 2, 3:

$$\sum ( {\vec{F}}_{ext}^{nc} \cdot \frac{\partial \vec{r}}{\partial {q}_{i}} ) = {F}_{x}^{lift} \frac{\partial {x}_{K}}{\partial {q}_{i}} + {F}_{y}^{lift} \frac{\partial {y}_{K}}{\partial {q}_{i}} + {F}_{x}^{tilt} \frac{\partial {x}_{E}}{\partial {q}_{i}} + {F}_{y}^{tilt} \frac{\partial {x}_{E}}{\partial {q}_{i}} + {F}_{x}^{resis} \frac{\partial {x}_{tip}}{\partial {q}_{i}} + {F}_{y}^{resis} \frac{\partial {x}_{tip}}{\partial {q}_{i}} + {F}_{x}^{i n t} \frac{\partial {x}_{A}}{\partial {q}_{i}} + {F}_{y}^{i n t} \frac{\partial {y}_{A}}{\partial {q}_{i}} \qquad ( 9 )$$

By immersing Equations (5), (6), and (9) into Equation (1), the following Equations (10) and (10) may be obtained, where (Fₓ^{resis} and F_{y}^{resis}) represent the external resistive forces applied to the system (e.g., linkage assembly 30):

$$\{ \begin{matrix}\frac{d}{d t} ( \frac{\partial ℒ}{\partial {\dot{q}}_{1}} ) - \frac{\partial ℒ}{\partial {q}_{1}} = {Q}_{1} + {F}_{x}^{resis} \frac{\partial {x}_{tip}}{\partial {q}_{1}} + {F}_{y}^{resis} \frac{\partial {y}_{tip}}{\partial {q}_{1}} \\ \frac{d}{d t} ( \frac{\partial ℒ}{\partial {\dot{q}}_{2}} ) - \frac{\partial ℒ}{\partial {q}_{2}} = {Q}_{2} + {F}_{x}^{resis} \frac{\partial {x}_{tip}}{\partial {q}_{2}} + {F}_{y}^{resis} \frac{\partial {y}_{tip}}{\partial {q}_{2}}\end{matrix} \qquad ( 10 )$$

$$[ \begin{matrix}\frac{\partial {x}_{tip}}{\partial {q}_{1}} & \frac{\partial {y}_{tip}}{\partial {q}_{1}} \\ \frac{\partial {x}_{tip}}{\partial {q}_{2}} & \frac{\partial {x}_{tip}}{\partial {q}_{2}}\end{matrix} ] [ \begin{matrix}{F}_{x}^{resis} \\ {F}_{y}^{resis}\end{matrix} ] = [ \begin{matrix}\frac{d}{d t} ( \frac{\partial ℒ}{\partial {\dot{q}}_{2}} ) - \frac{\partial ℒ}{\partial {q}_{1}} - {Q}_{1} \\ \frac{d}{d t} ( \frac{\partial ℒ}{\partial {\dot{q}}_{2}} ) - \frac{\partial ℒ}{\partial {q}_{2}} - {Q}_{2}\end{matrix} ] \qquad ( 11 )$$

Variables Q₁ and Q₂ shown in Equations (10) and (11) above are expressed below in Equation (12) for i=1,2:

$${Q}_{i} = {F}_{x}^{lift} \frac{\partial {x}_{K}}{\partial {q}_{i}} + {F}_{y}^{lift} \frac{\partial {y}_{K}}{\partial {q}_{i}} + {F}_{x}^{tilt} \frac{\partial {x}_{E}}{\partial {q}_{i}} + {F}_{y}^{tilt} \frac{\partial {y}_{E}}{\partial {q}_{i}} \qquad ( 12 )$$

Thus, in this example and using a Lagrangian model, the external resistive forces (Fₓ^{resis} and F_{y}^{resis}) applied to linkage assembly 30 may be estimated from pressure data collected from cylinders 38 and 40 (embedded in Q₁ and Q₂) and displacement data of cylinders 38 and 40 and of the vehicle itself (e.g., q₁, q₂, and q₃) by solving for Equation (12) above.

Referring briefly again to FIG. 2, the model parameter estimator 20 of force prediction system 10 is generally configured to estimate parameters 21 for the integrated model 22 using the information provided by tool variable estimator 18, Particularly, model parameter estimator 20 estimates the parameters 21 for the integrated model 22 (e.g., adhesion coefficients, soil cohesion coefficient, weighting functions used in one or more neural networks of the integrated model 22) from the estimated resistive forces 19 and estimates motions/trajectories of the tool of the industrial machine provided by tool variable estimator 18 (e.g., as described above with reference to the example shown in FIG. 3).

As will be discussed further herein, integrated model 22 integrates a physical model with a black box model for providing the predicted resistive forces 16. Additionally, while the model 22 shown in FIG. 2 comprises an integrated model, it may be understood that in other embodiments model 22 may vary. For instance, in certain embodiments, model 22 may comprise only a physical model and not a black box model.

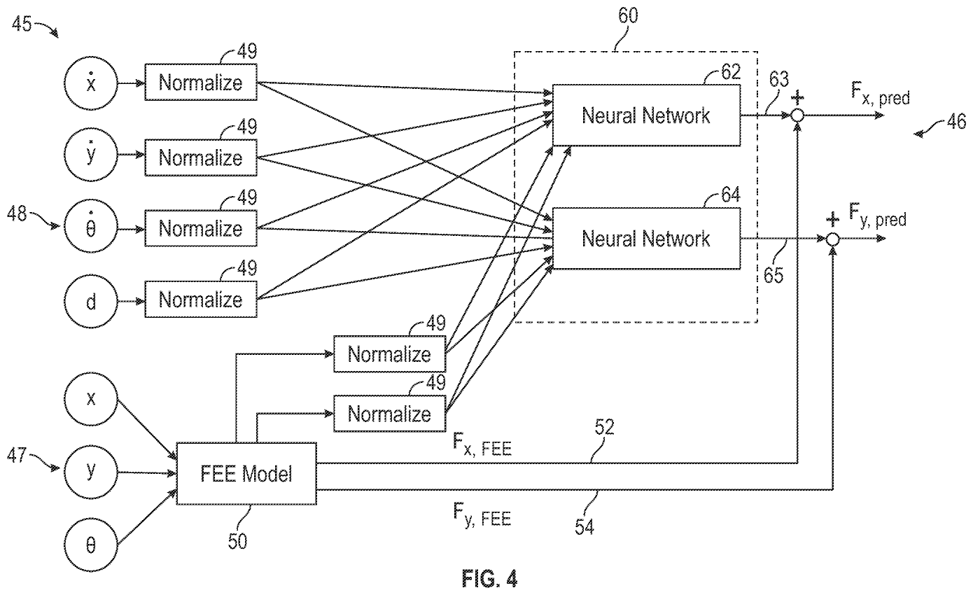

Referring to FIG. 4, an embodiment of an integrated model 45 is shown. In certain embodiments, the integrated model 22 of force prediction system 10 shown in FIG. 2 comprises or corresponds to integrated model 45; however, in other embodiments, integrated model 22 varies in configuration from integrated model 45. In this exemplary embodiment, integrated model 45 generally includes a physical model 50 and a data-driven or black box model 60 which operate in parallel to produce or generate one or more predicted external resistive forces 46 (indicated as F_{x,pred} and F_{y,pred} in FIG. 4). In some embodiments, predicted resistive forces 16 shown in FIG. 2 includes or corresponds to the predicted external resistive forces 46,

In this exemplary embodiment, physical model 50 of integrated model 45 comprises a FEE model (and thus physical model 50 may also be referred to herein as FEE model 50) and is illustrated in FIG. 4 as comprising such; however, in other embodiments, physical model 50 may comprise physical models other than FEE models.

The physical model 50 of integrated model 45 receives a first input dataset 47 (e.g., obtained from the planned working cycle input 12 shown in FIG. 2.) while the black box model 60 receives a second input dataset 48 (e.g., again obtained from the planned working cycle input 12 shown in FIG. 2,) that is different from the first input dataset 47. It may also be understood that, in addition to datasets 47 and 48, initial parameters of integrated model 45 (e.g., soil adhesion coefficients, NN weighting functions) are provided by the model parameter estimator 20. The input datasets 47 and 48 correspond, in some embodiments, to the estimated position and/or motion of a tool of an industrial machine. In this exemplary embodiment, first input dataset 47 includes first input parameters x, y, and θ where x and y represent the position of the (X,Y) position of the tool while θ represents the angle of the tool relative to a horizontal axis (e.g., horizontal relative to the direction of gravity).

In addition, in this exemplary embodiment, second input dataset 48 includes second input parameters \dot{x}, \dot{y}, \dot{θ}, and d which are different from the first input parameters where second input parameters \dot{x}, \dot{y}, \dot{θ} represent the derivatives (e.g., velocities) of the first input parameters x, y, and θ while d represents the distance between a tip of the tool (e.g., the tool tip) and the external material to be engaged by the tool (e.g., the distance from the bucket tip to the soil pile in one example), It may be understood that the first input parameters of first input dataset 47 and/or the second input parameters of the second input dataset 48 may vary from that shown in FIG. 4, As an example, in certain embodiments, first input dataset 47 can include input parameters \dot{x}, \dot{y}, as input parameters, Additionally, in certain embodiments, second input dataset 48 may include the derivative of d along with the second derivatives of x, y, and θ.

FEE model 50 is generally configured to generate or produce one or more predicted external resistive forces 52 and 54 (indicated as F_{x,FEE} and F_{x,FEE}, respectively, in the exemplary embodiment shown in FIG. 4) applied to a tool of an industrial machine). In certain embodiments, the predicted external resistive forces 52 and 54 correspond to a global coordinate frame. Additionally, in some embodiments, predicted external resistive forces 52 and 54 relate to different directions of the global coordinate frame (e.g., the x and y directions, respectively), However, it may be understood that in other embodiments FEE model may instead produce only a single predicted external resistive force (e.g., corresponding to a single direction) or more than two predicted external resistive forces.

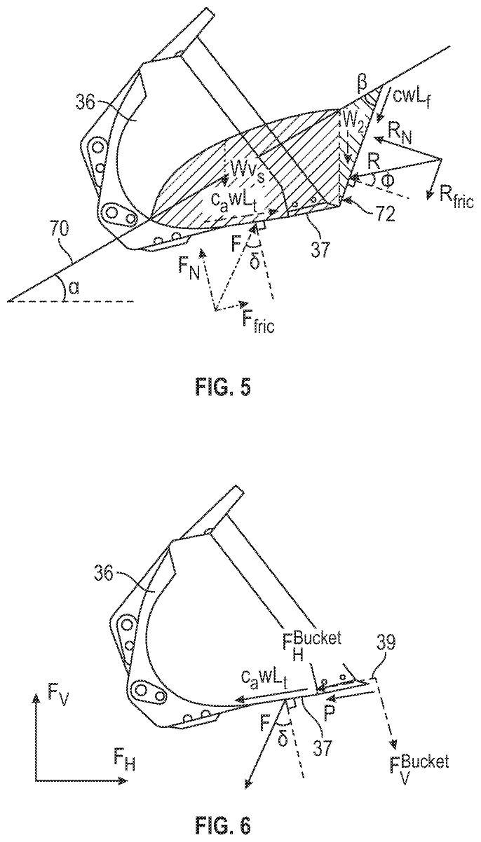

Referring to FIG. 5, a diagram illustrating bucket 36 of linkage assembly 30 engaging (e.g., scooping or excavating) external aggregate material 70 in the form of a soil pile. It may initially be understood that reference to the diagram of FIG. 5 is meant only to serve as one illustrative example of the implementation of the FEE model 50 shown in FIG. 4, and thus the process for implementing FEE model 50 described below may similarly be applied to industrial machines having linkage systems which differ in configuration from the linkage assembly 30 comprising the bucket 36.

In this example, there are six distinct forces involved during the scooping process illustrated in FIG. 5: (1) the weight of the external aggregate material 70 (e.g., soil) accumulated within the bucket (indicated as W_{V}_{ₛ} in FIG. 5) which may equal (γwgVₛ) where (γ) represents the density of the aggregate material 70, (w) represents the width of the bucket, and (Vₛ) represents the cross-sectional area of the aggregate material 70 internal bucket 36; (2) the weight of the aggregate material 70 external of but engaged by bucket 36 (indicated as W₂ in FIG. 5) which may equal (γwgV₂) where (V₂) represents the cross-sectional area of the aggregate material 70 external bucket 36; (3) the adhesion force (indicated as cₐwLₜ in FIG. 5) where (cₐ) represents the adhesion coefficient of the aggregate material 70 and bucket 36, and (Lₜ) represents the length of a blade 37 of the bucket 36 that is inserted into the aggregate material 70; (4) the net force (F) comprising the combination of the normal force (indicated as Fₙ in FIG. 5) and the friction force (indicated as F_{fric} in FIG. 5) between bucket 36 and aggregate material 70 where the angle (δ) indicated in FIG. 5 is assumed, in this example, to be a constant parameter; (5) the net force (R) comprising the combination of the normal force (indicated as Rₙ in FIG. 5) and the friction force (indicated as R_{fric} in FIG. 5) between bucket 36 and aggregate material 70 where the angle (ϕ) indicated in FIG. 5 is assumed, in this example, to be a constant parameter; and (6) the soil cohesion force (indicated as cwL_{f} in FIG. 5) between affected aggregate material 70 and unaffected aggregate material 70 where (c) represents the cohesion coefficient of aggregate material 70 and (L_{f}) represents the length of a failure surface 72 of aggregate material 70.

Not intending to be bound by any particular theory, by assuming the aggregate material 70 is in equilibrium, the six forces listed above may be expressed as a pair of force balancing equations represented below in Equations (13) and (14) in the x and y directions, where (β) represents the angle between aggregate material 70 and failure surface 72:

$$\begin{matrix}\sum {F}_{x} = {c}_{a} w {L}_{t} cos θ - c w {L}_{f} cos ( α + β ) + \\ F sin ( δ - θ ) - R sin ( α + β + ϕ ) \\ = 0\end{matrix} \qquad ( 13 )$$

$$\begin{matrix}\sum {F}_{x} = - γ w g {V}_{s} - γ w g {V}_{s} + {c}_{a} ω {L}_{t} sin θ + \\ F cos ( δ - θ ) - R cos ( α + β + ϕ ) - \\ c ω w {L}_{f} sin ( α + β ) \\ = 0\end{matrix} \qquad ( 14 )$$

In this example, γ, cₐ, c, δ, and ϕ are parameters of aggregate material 70, w and a are fixed and knowable in advance, and θ, Lₜ, L_{f}, Vₛ, and V₂ vary during the scooping operation but may be estimated. Thus, in this example, the only unknowns are forces F and R where force F is a part of the material-tool interaction. Not intending to be bound by any particular theory, force F may be expressed in accordance with Equation (15) provided below by eliminating the force R:

F=d²wγgN_{γ}+cwdN_{c}+cₐwdNₐ+Vₐ+VₛwγgN_{q} (15)

Parameters N_{γ}, N_{c}, Nₐ, and N_{q} of Equation (15) may be expressed in accordance with Equations (16)-(19), respectively presented below:

$${N}_{γ} = \frac{( cot β - tan α ) ( cos α + sin α cot ( β + ϕ ) )}{2 [ cos ( α - θ + δ ) + sin ( α - θ + δ ) cot ( β + ϕ ) ]} \qquad ( 16 )$$

$${N}_{c} = \frac{1 + cot βcot ( β + ϕ )}{cos ( α - θ + δ ) + sin ( α - θ + δ ) cot ( β + ϕ )} \qquad ( 17 )$$

$${N}_{a} = \frac{1 + cot βcot ( β + ϕ )}{cos ( α - θ + δ ) + sin ( α - θ + δ ) cot ( β + ϕ )} \qquad ( 18 )$$

$${N}_{q} = \frac{cos α + sin αcot ( β + ϕ )}{cos ( α - θ + δ ) + sin ( α - θ + δ ) cot ( β + ϕ )} \qquad ( 19 )$$

Referring to FIG. 6, an additional diagram of bucket 36 is shown illustrating the forces F and cₐwLₜ acting on the bucket 36 in a bucket coordinate system including axes F_{V} and F_{H}. Additionally, FIG. 6 illustrates an additional penetrating force P acting on the bucket 36. Not intending to be bound by any particular theory, penetrating force P may be expressed in accordance with Equation (20) presented below, where k_{c}, k_{ϕ}, and n represent parameters of the aggregate material 70, and b represents the penetrating width of bucket 36:

$$P = w b ( \frac{{k}_{c}}{b} + {k}_{ϕ} ) {d}^{n} \qquad ( 30 )$$

Not intending to be bound by any particular theory, the external resistive forces (indicated as F_{H}^{Bucket} and F_{V}^{Bucket} in FIG. 6) acting on the bucket 36 (e.g., a tip 39 of the bucket 36) may be expressed in accordance with Equations (21) (presented in the bucket coordinate system shown in FIG. 6) and (22) (presented as external resistive forces F_{H} and F_{V} using the global (x,y) coordinate system shown in FIG. 3):

F_{H}^{Bucket}=P+F sinδ+cₐwLₜ F_{V}^{Bucket}=F cosδ (21)

F_{H}=−F_{H}^{Bucket}cosθ+F_{V}^{Bucket} sinθF_{V}=−F_{H}^{Bucket} sinθ−F_{V}^{Bucket} cosθ(22)

Thus, as described above, an example of predicting external resistive forces (with respect to a global coordinate system) applied to a tool of an industrial machine is provided using the FEE model 20 shown in FIG. 2.

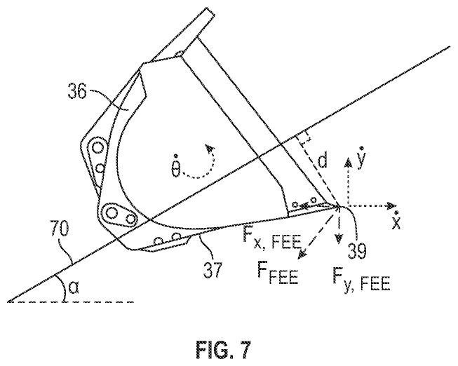

Referring now to FIGS. 4 and 7, black box model 60 is generally configured to improve the performance (e.g., the accuracy) of the predicted external resistive forces produced by the FEE model 50. Particularly, although the FEE model 50 can capture the trend or the overall mean value of the external resistive force, FEE model 50 may struggle with transient behavior of the external resistance force given that the physics considered in the FEE model 50 are simplified and thus cannot capture all of the complexities of external material-tool interaction dynamics. As an example, the impact of velocity of bucket 36 on the external material-tool interaction dynamics is not considered by FEE model 50 and the equilibrium equations of FEE model 50 are considered in a static condition instead of a dynamic condition. Further, only sliding friction is considered by FEE model 50 while other types of friction also exist in real world working conditions.

Black box model 60 is generally configured to compensate for the deficiencies of FEE model 50 noted above, In this exemplary embodiment, black box model 60 comprises a machine learning (ML) model and thus may also be referred to herein as ML model 60. ML model 60 includes a pair of NNs 62 and 64 which operate in parallel. A first NN 62 of the pair of NNs 62 and 64 generates or produces a first output 63 while a second NN 64 of the pair of NNs 62 and 64 generates or produces a second output 65 that is different from the first output 63. Particularly, in this exemplary embodiment, first output 63 comprises a first predicted error 63 of the first predicted external resistive force 52 produced by FEE model 50 while second output 65 comprises a second predicted error 65 of the predicted external resistive force 54. In some embodiments, the predicted external resistive forces 46 of integrated model 45 are produced by combining the first predicted external resistive force 52 with the first predicted error 63 and by combining the second predicted external resistive force 54 with the second predicted error 65. Thus, predicted external resistive forces 46 is also referred to herein as corrected predicted external resistive forces 46. Not intending to be bound by any particular theory, the corrected predicted external resistive forces 46 (indicated as F_{x,pred} and F_{y,pred} in FIG. 4) may be expressed in accordance with Equation (23) presented below, where (ΔF_{x,NN}) and (ΔF_{y,NN}) represent the predicted errors 63 and 65 produced by NNs 62 and 64:

F_{x,pred}=F_{x,FEE}+ΔF_{x,NN} F_{y,pred}=F_{y,FEE}+ΔF_{y,NN} (23)

Each NN 62 and 64 receive as inputs each of the second input parameters of the second input dataset 48 along with the predicted external resistive forces 52 and 53 produced by FEE model 50. For convenience, the inputs applied to the ML model 60 are indicated in the diagram of the bucket 36 presented in FIG. 7. The velocities of bucket 36 (or other tool of a given industrial machine) are selected as inputs in order to particularly improve the performance of FEE model 50 with respect to transient behavior of the bucket 36. In addition, in certain embodiments, for the purpose of training NNs 62 and 64, each of the input parameters of the second input dataset 48 and the external resistive forces 52 and 53 are normalized via a corresponding normalizer 49 of integrated model 45.

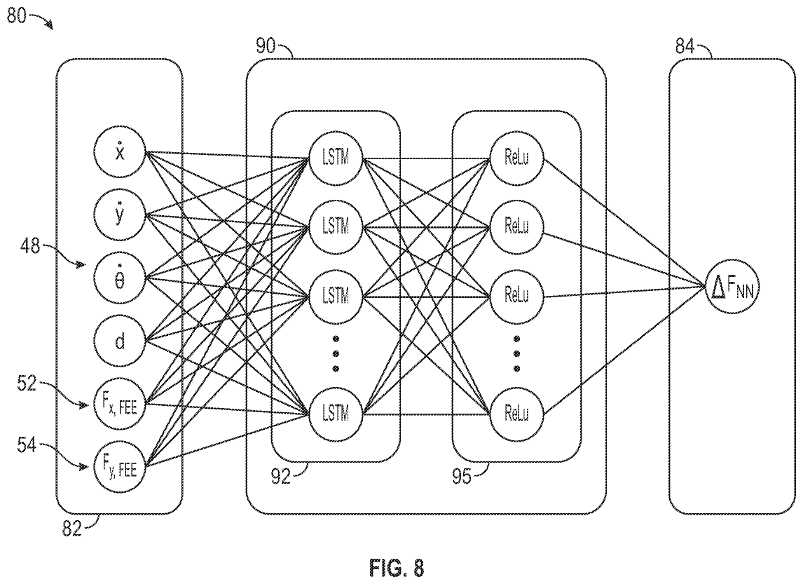

Referring to FIG. 8, an embodiment of a NN 80 is shown. In certain embodiments, NNs 62 and 64 comprise or otherwise correspond to NN 80; however, it may be understood that in other embodiments NNs 62 and 64 may vary in configuration from NN 80. In this exemplary embodiment, NN 80 comprises a recurrent neural network (RNN) and thus may also be referred to as RNN 80. RNN 80 is provisioned with a memory of values of past dynamical states (e.g., of the tool of the industrial machine) which may be used by RNN 80 to learn dynamical effects which have a phase delay and/or are dependent on past state trajectories. As an example, in the FEE model 50, the depth of the bucket tip 39 is calculated based on the initial pile geometry of external material 70 before the bucket 36 scoops into the pile of external material 70. However, the geometry of the pile of external material 70 may change as the bucket 36 scoops some of the external material 70 upwards, and the change of the geometry of the pile of external material 70 can depend on the respective trajectory of the bucket 36 after scooping into the pile of external material 70. In some embodiments, RNN 80 learns how the trajectory of bucket 36 within the same scooping cycle may affect d. Thereafter, the value of d calculated using the initial geometry of the pile of external material 70 may also be included as one of the input parameters to the RNN 80 to serve as a baseline value.

In this exemplary embodiment, RNN 80 includes an input layer 82, an output layer 84, and a plurality of hidden layers 90 positioned between the input layer 82 and the output layer 84. Each of layers 82, 84, and 90 comprise one or more interconnected nodes where information flows from the nodes of input layer 82 to the one or more hidden layers 90, and from the one or more hidden layers 90 to the output layer 84. In this manner, the one or more hidden layers 90 are located downstream from the input layer 82 while the output layer 84 are located downstream from the one or more hidden layers 90.

The input layer 82 of RNN 80 comprises a plurality of input nodes corresponding to the second input parameters of second input dataset 48 along with the predicted external resistive forces 52 and 54 produced by FEE model 50. By including the predicted external resistive forces 52 and 54 produced by FEE model 50 as input nodes, correlations between the modeling error of FEE model 50 and the magnitude of the force predicted by FEE model 50 may be formed by RNN 80. The output layer 84 of RNN 80 comprises an output node corresponding to one of the predicted errors 63 and 65 (e.g., either first predicted error 63 or second predicted error 65).

In this exemplary embodiment, the one or more hidden layers 90 of RNN 80 includes a first hidden layer 92 and a second hidden layer 94 located downstream from the first hidden layer 92. Particularly, first hidden layer 92 comprises a long short-term memory (LSTM) layer 92 while second hidden layer 94 comprises a rectifier linear unit (ReLu) layer 94. The LSTM layer 92 is generally configured to handle the memory of the sequential data whereby past dynamical effects may be captured by the RNN 80 while ReLu layer 94 may enhance the trainability of RNN 80. Although in this exemplary embodiment RNN 80 includes a LSTM layer 92 and a ReLu layer 94, it may be understood that in other embodiments RNN 80 may be structured differently than the configuration shown in FIG. 8. For example, in other embodiments, the hidden layers 90 of RNN 80 may comprise a sigmoid layer, a tanh layer, and/or others.

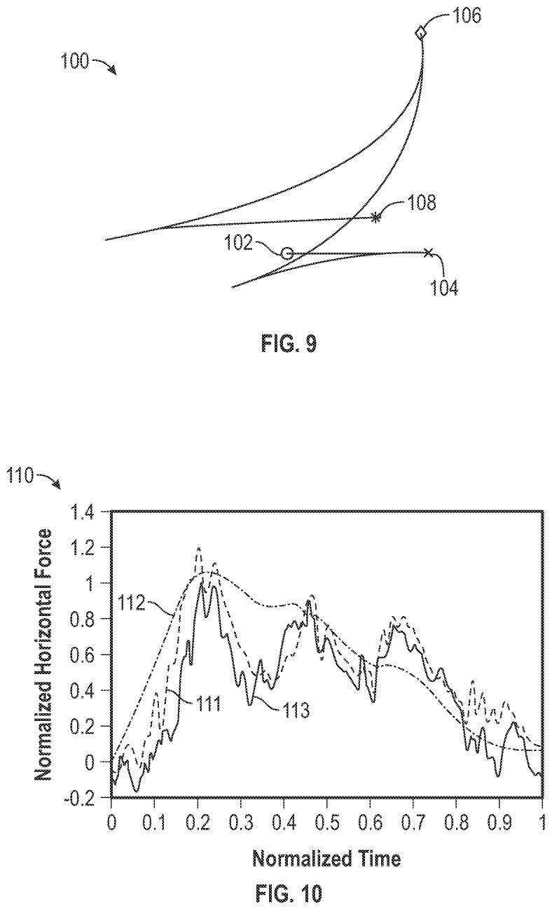

Referring now to FIG. 9, an exemplary working cycle 100 of an industrial machine is shown. In this example, the industrial machine comprises a wheel loader and during the working cycle 100 the wheel loader travels from a start position 102 to a digging position 104 to scoop or excavate external aggregate material (e.g., son). From the digging position 104, the wheel loader travels to a dumping position 106 where the wheel loader dumps the aggregate material excavated at the digging position 104. After dumping, in this example, the wheel loader travels from the dumping position 106 to an end position 108. In some embodiments, the end position 108 comprises the start position for a following working cycle 100 of the wheel loader.

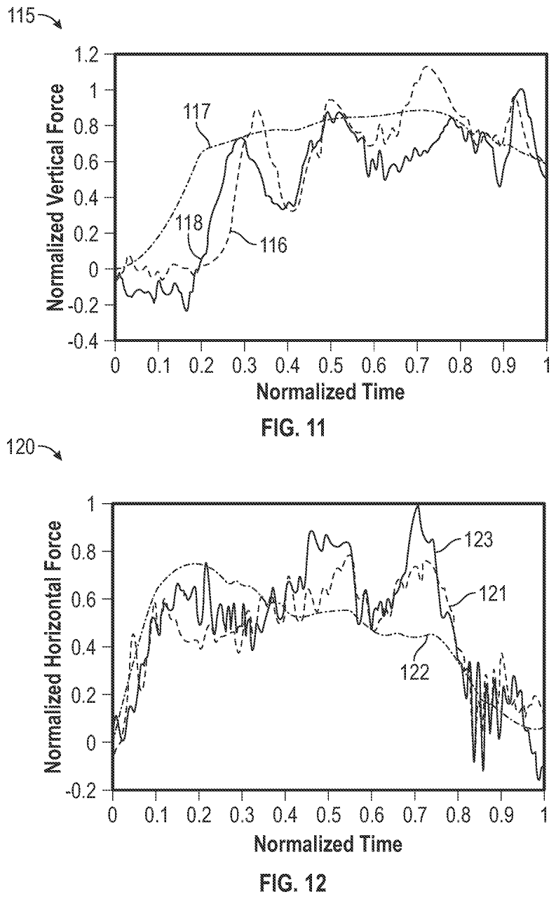

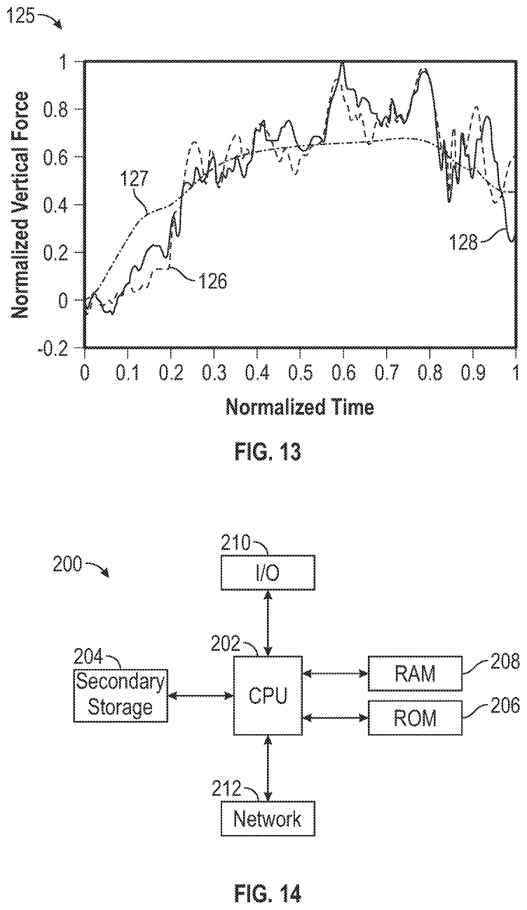

In certain embodiments, the force prediction system 10 of FIG. 2 may be employed to predict the material-tool interaction force for the excavating phase of future working cycles 100 performed by the wheel loader based on information collected from the performance of previous working cycles 100. Referring to FIGS. 10-13, graphs 110, 115, 120, and 125 are shown illustrating exemplary results comparing the material-tool interaction force predicted by system 10 (indicated by curves 111, 116, 121, and 126, respectively, in graphs 110, 115, 120, and 125) with the material-tool interaction force predicted by a FEE model (indicated by curves 112, 117, 122, and 127, respectively, in graphs 110, 115, 120, and 125) and the actual material-tool interaction force (indicated by curves 113, 118, 123, and 128, respectively, in graphs 110, 115, 120, and 125). In this example, the material-tool interaction forces plotted in graphs 110, 115, 120, and 125 are plotted in accordance with a global coordinate frame with graphs 110 and 120 illustrating forces in the horizontal direction (F_{H}) and graphs 115 and 125 illustrating forces in the vertical direction (F_{V}).

In the example presented in FIGS. 10-13, the material-tool interaction forces predicted by system 10 (e.g., curves 111, 116, 121, and 126) is generally closer to the actual data (e.g., curves 113, 118, 123, and 128) than the material-tool interaction forces predicted by the FEE model (e.g., curves 112, 117, 122, and 127). Particularly, Table 1 below illustrates prediction time and area-based errors for the integrated (or hybrid) model as compared with the FEE model in this example for both the training and validation cycles.

TABLE 1

| | Prediction | Horizontal | Vertical |
|---|---|---|---|
| | Time | Force Error | Force Error |
| FEE Model | 0.0907 s | 16.60% | 23.45% |
| (Training) | | | |
| Hybrid | 0.1141 s | 7.67% | 9.46% |
| Model | | | |
| (Training) | | | |
| FEE Model | 0.0927 s | 19.58% | 18.92% |
| (Validation) | | | |
| Hybrid | 0.1211 s | 14.77% | 10.54% |
| Model | | | |
| (Validation) | | | |

The area-based error indicated in Table 1 corresponds to the difference between the predicted area under the curve (e.g., the area under curves 111, 116, 121, and 126 for the integrated/hybrid model, the area under curves 112, 117, 122, and 126 for the FEE model) and the actual rea under the curve (e.g., the area under curves 113, 118, 123, and 128) divided by the actual area under the curves. Table 1 generally indicates that for the validation set of this example, the integrated/hybrid model significantly reduces errors as compared to the FEE model. In particular, in the vertical direction, the estimation error drops from approximately 23.45% to 9.46% in training, and drops from approximately 18.92% to 10.54% in validation. In addition, the integrated/hybrid model takes a longer but still short enough time to predict the force (e.g., 0.11-0.12s) than the FEE model.

As an example, and referring to FIG. 14, an embodiment of a computer system 200 is shown suitable for implementing one or more components (e.g., force prediction system 10 shown in FIG. 2, integrated model 40 shown in FIG. 4) disclosed herein. The computer system 200 of FIG. 8 includes a processor 202 (which may be referred to as a central processor unit or CPU) that is in communication with memory devices including secondary storage 204, read only memory (ROM) 206, random access memory (RAM) 208, input/output (I/O) devices 210, and network connectivity devices 212. The processor 202 may be implemented as one or more CPU chips. It is understood that by programming and/or loading executable instructions onto the computer system 200, at least one of the CPU 202, the RAM 208, and the ROM 206 are changed, transforming the computer system 200 in part into a particular machine or apparatus having the novel functionality taught by the present disclosure.

Additionally, after the system 200 is turned on or booted, the CPU 202 may execute a computer program or application. For example, the CPU 202 may execute software or firmware stored in the ROM 206 or stored in the RAM 208. In some cases, on boot and/or when the application is initiated, the CPU 202 may copy the application or portions of the application from the secondary storage 204 to the RAM 208 or to memory space within the CPU 202 itself, and the CPU 202 may then execute instructions that the application is comprised of. In some cases, the CPU 202 may copy the application or portions of the application from memory accessed via the network connectivity devices 212 or via the I/O devices 210 to the RAM 208 or to memory space within the CPU 202, and the CPU 202 may then execute instructions that the application is comprised of. During execution, an application may load instructions into the CPU 202. for example load some of the instructions of the application into a cache of the CPU 202. In some contexts, an application that is executed may be said to configure the CPU 202 to do something, e.g., to configure the CPU 202 to perform the function or functions promoted by the subject application. When the CPU 202 is configured in this way by the application, the CPU 202 becomes a specific purpose computer or a specific purpose machine.

Secondary storage 204 may be used to store programs which are loaded into RAM 208 when such programs are selected for execution. The ROM 206 is used to store instructions and perhaps data which are read during program execution. ROM 206 is a non-volatile memory device which typically has a small memory capacity relative to the larger memory capacity of secondary storage 204. The secondary storage 204, the RAM 208, and/or the ROM 206 may be referred to in some contexts as computer readable storage media and/or non-transitory computer readable media. I/O devices 210 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 212 may take the form of modems, modem banks, Ethernet cards, universal serial bus (USB) interface cards, wireless local area network (WLAN) cards, radio transceiver cards, and/or other well-known network devices. The network connectivity devices 212 may provide wired communication links and/or wireless communication links. These network connectivity devices 212 may enable the processor 202 to communicate with the Internet or one or more intranets. With such a network connection, it is contemplated that the processor 202 might receive information from the network, or might output information to the network. Such information, which may include data or instructions to be executed using processor 202 for example, may be received from and outputted to the network, for example, in the form of a computer data baseband signal or signal embodied in a carrier wave.

The processor 202 executes instructions, codes, computer programs, scripts which it accesses from hard disk, floppy disk, optical disk, flash drive, ROM 206, RAM 208, or the network connectivity devices 212, While only one processor 202 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 204, for example, hard drives, floppy disks, optical disks, and/or other device, the ROM 206, and/or the RAM 208 may be referred to in some contexts as non-transitory instructions and/or non-transitory information.

In an embodiment, the computer system 200 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, the functionality disclosed above may be provided by executing the application and/or applications in a cloud computing environment. Cloud computing may comprise providing computing services via a network connection using dynamically scalable computing resources.

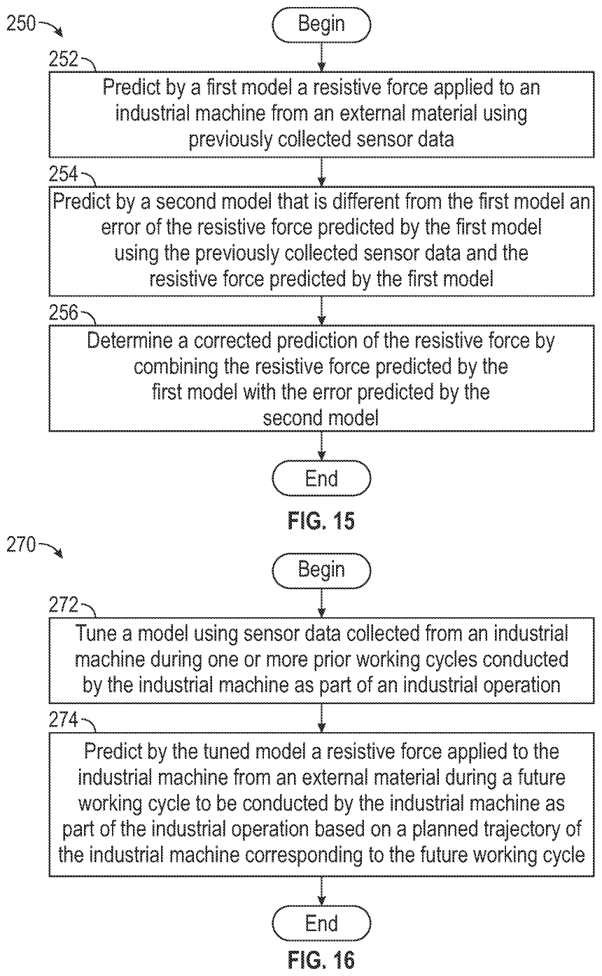

Referring now to FIG. 15, an embodiment of a method 250 for predicting external resistive forces encountered by an industrial machine (e.g., industrial machine 1 shown in FIG. 1) is shown. Initially at block 252, method 250 comprises predicting by a first model (e.g., FEED model 50 shown in FIG. 4) a resistive force (e.g., predict external resistive forces 52 and/or 54 shown in FIG. 4) applied to an industrial machine from an external material (e.g., external material 8 shown in FIG. 1) using previously collected sensor data.

At block 254, method 250 comprises predicting by a second model (e.g., black box model 60 shown in FIG. 4) that is different from the first model an error (e.g., errors 63 and/or 65 shown in FIG. 4) of the resistive force predicted by the first model using the previously collected sensor data and the resistive force predicted by the first model. At block 256, method 250 comprises determining a corrected prediction of the resistive force (e.g., corrected predicted external resistive forces 46 shown in FIG. 4) by combining the resistive force predicted by the first model with the error predicted by the second model. In certain embodiments, blocks 256 of method 250 is performed online utilizing the predicted external resistive forces 46 for controlling an industrial machine in real-time. In other embodiments, block 256 is performed offline (e.g., not as part of real-time control system) as part of a planning or evaluation phase of an industrial operation.

Referring now to FIG. 16, an embodiment of a method 270 for predicting external resistive forces encountered by an industrial machine (e.g., industrial machine 1 shown in FIG. 1) is shown. Initially at block 272, method 270 comprises tuning a model (e.g., integrated model 22 shown in FIG. 2) using sensor data collected from an industrial machine (e.g., collected from cylinders 5 and 6 shown in FIG. 1) during one or more prior working cycles (e.g., working cycle 100 shown in FIG. 9) conducted by the industrial machine as part of an industrial operation. In some embodiments, the model tuned at block 272 comprises an integrated model including a physical model and a block box model. In other embodiments, the model tuned at block 272 comprises only a physical model and not a black box model.

At block 274, method 270 comprises predicting by the tuned model a resistive force (e.g., predicted external resistive force 16 shown in FIG. 2) applied to the industrial machine from an external material (e.g., external material 8 shown in FIG. 1) during a future working cycle to be conducted by the industrial machine as part of the industrial operation based on a planned trajectory of the industrial machine (e.g., planned working cycle input 12 shown in FIG. 2) corresponding to the future working cycle.

While embodiments of the disclosure have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A computer-implemented method for predicting external resistive forces encountered by an industrial machine, the method comprising:
(a) predicting by a first model a resistive force applied to an industrial machine from an external material using previously collected sensor data;
(b) predicting by a second model that is different from the first model an error of the resistive force predicted by the first model using the previously collected sensor data and the resistive force predicted by the first model; and
(c) determining a corrected prediction of the resistive force by combining the resistive force predicted by the first model with the error predicted by the second model.

2. The method of claim 1, wherein the first model comprises a physical model and the second model comprises one or more neural networks.

3. The method of claim 1, wherein the sensor data is collected from one or more sensors of the industrial machine.

4. The method of claim 3, wherein the one or more sensors are associated with one or more actuators of the industrial machine.

5. The method of claim 1, wherein the sensor data comprises pressure sensor data collected from one or more pressure sensors of the industrial machine.

6. The method of claim 1, further comprising:
(d) extracting position data and velocity data of a tool of the industrial machine using the previously collected sensor data;
(e) providing as an input to the first model the position data of the tool; and
(f) providing as an input to the second model the velocity data of the tool.

7. The method of claim 1, wherein the second model comprises a neural network having an input layer including the resistive force predicted by the first model, an output layer including the error predicted by the second model, and one or more hidden layers positioned between the input layer and the output layer.

8. The method of claim 1, wherein:
the previously collected sensor data comprises sensor data collected from the industrial machine during one or more prior working cycles conducted by the industrial machine as part of an industrial operation; and
the corrected prediction of the resistive force corresponds to a resistive force applied to the industrial machine from an external material during a future working cycle to be conducted by the industrial machine as part of the industrial operation based on a planned trajectory of the industrial machine corresponding to the future working cycle.

9. A computer-implemented method for predicting external resistive forces encountered by an industrial machine, the method comprising:
(a) tuning a model using sensor data collected from an industrial machine during one or more prior working cycles conducted by the industrial machine as part of an industrial operation; and
(b) predicting by the tuned model a resistive force applied to the industrial machine from an external material during a future working cycle to be conducted by the industrial machine as part of the industrial operation based on a planned trajectory of the industrial machine corresponding to the future working cycle.

10. The method of claim 9, wherein the one or more prior working cycles and the future working cycle each comprise an excavating phase in which a tool of the industrial machine excavates a portion of the external material from a pile of the external material.

11. The method of claim 10, wherein the planned trajectory of the industrial machine comprises a planned trajectory of a tool of the industrial machine to be executed during the excavation phase of the future working cycle.

12. The method of claim 9, wherein the model comprises a neural network.

13. The method of claim 9, wherein the model comprises an integrated model including both a physical model and a black box model including one or more neural networks.

14. The method of claim 9, wherein the model comprises a physical model but not a black box model.

15. The method of claim 9, wherein the sensor data is collected from one or more sensors of the industrial machine.

16. The method of claim 9, further comprising:
(c) extracting position data and velocity data of a tool of the industrial machine using previously collected sensor data;
(d) providing as an input to the model the position data of the tool; and
(e) providing as an input to the model the velocity data of the tool.

17. The method of claim 9, wherein the model comprises a neural network having an input layer including the resistive force predicted by the first model, an output layer, and one or more hidden layers positioned between the input layer and the output layer.

18. A system for predicting external resistive forces encountered by an industrial machine, the system comprising:
a processor;
a non-transitory memory; and
one or more applications stored in the non-transitory memory that, when executed by the processor:
predict by a first model stored in the non-transitory memory a resistive force applied to an industrial machine from an external material using previously collected sensor data;
predict by a second model stored in the non-transitory memory that is different from the first model an error of the resistive force predicted by the first model using the previously collected sensor data and the resistive force predicted by the first model; and
determine a corrected prediction of the resistive force by combining the resistive force predicted by the first model with the error predicted by the second model.

19. The system of claim 18, wherein the one or more applications stored in the non-transitory memory that, when executed by the processor:
extract position data and velocity data of a tool of the industrial machine using the previously collected sensor data;
provide as an input to the first model the position data of the tool; and
provide as an input to the second model the velocity data of the tool.

20. The system of claim 18, wherein:
the previously collected sensor data comprises sensor data collected from the industrial machine during one or more prior working cycles conducted by the industrial machine as part of an industrial operation; and
the corrected prediction of the resistive force corresponds to a resistive force applied to the industrial machine from an external material during a future working cycle to be conducted by the industrial machine as part of the industrial operation based on a planned trajectory of the industrial machine corresponding to the future working cycle.
